(19) United States
(12) Patent Application Publication
(10) Pub. No.: US 2023/0356710 A1
(43) Pub. Date: Nov. 9, 2023

(54) AUTO PARKING PLANNING SYSTEM AND METHOD

(71) Applicant: Faraday&Future Inc., Gardena, CA (US)

(72) Inventors: Aohan Mei, San Jose, CA (US); Chen Zhang, Santa Clara, CA (US); Fan Wang, Palo Alto, CA (US)

(21) Appl. No.: 17/736,762

(22) Filed: May 4, 2022

(51) Int. Cl. B60W 30/06; B60W 50/00

(52) U.S. Cl. CPC B60W 30/06; B60W 50/00; B60W 2050/0019

(57) ABSTRACT

An auto parking system of a vehicle is disclosed. The auto parking system includes a planner initialization module configured to perform sampling of both a start state representing a state of the vehicle and an end state representing a state of the parking target; a path planning module configured to perform tree iteration of a start tree from the start state and an end tree from the end state and connect nodes from the start tree and the end tree to generate path data; and a trajectory planning module configured to receive the path data from the path planning module and construct a trajectory of the vehicle based on the path data; where the start tree and end tree comprise two different types of tree structures.

### FIELD

This relates generally to an autonomous driver assistance system of a vehicle, and specifically relates to automatic parking planning features of an autonomous driver assistance system.

### BACKGROUND

With Autonomous Driver Assistance System (ADAS) and Autonomous Vehicle becoming more popular, a lot of companies started to incorporate ADAS into their products (e.g., vehicles). Auto-Parking (AP) (or self-parking), with the advantages of operating in a lower speed and a structured environment with less uncertainty and randomity than other driving environment such as traffic-packed roads, is identified as a common feature in ADAS software development.

Currently, there are several prominent methods to approach the auto-parking problem. Some of them rely on adding heuristic into well-known searching processes, such as A* and RRT*, while other systems try to blend vehicle kinematic models into sampling during searching, such as a hybrid A* search, in order to generate a more viable trajectory for the vehicle.

Nevertheless, those prominent methods incur tremendous computational cost due to either the delicate model that they blend in or the unreasonable and unnecessary randomity during sampling. A better and more efficient AP system is desired.

### SUMMARY

An auto parking system of a vehicle is disclosed. The auto parking system includes a planner initialization module configured to transform the key information and interfaces into favorable data structure for planner module to use; a path planning module configured to perform tree iteration of a start tree from the start state and an end tree from the end state and connect nodes from the start tree and the end tree to generate path data; and a trajectory planning module configured to receive the path data from the path planning module and construct a trajectory of the vehicle based on the path data; where the start tree and end tree comprise two different types of tree structures.

### BRIEF DESCRIPTION OF THE DRAWINGS

FIG. 1 illustrates the exemplary modules of an ADAS, according to one embodiment of the disclosure.

FIG. 2 is a block diagram illustrating the exemplary modules of an AP planner module of the ADAS of FIG. 1, according to an embodiment of the disclosure.

FIG. 3 is a block diagram illustrating the exemplary sub-modules of a planner initialization module of the AP planner module of FIG. 2, according to an embodiment of the disclosure.

FIG. 4 illustrates an exemplary step in a sampling method of sampling the searching configuration space, according to embodiments of the disclosure.

FIG. 5 illustrates the exemplary sub-modules of the path planning module of FIG. 2, according to an embodiment of the disclosure.

FIGS. 6a and 6b illustrate the exemplary results of the tree connection for perpendicular and parallel parking, respectively, according to an embodiment of the disclosure.

FIGS. 6c and 6d illustrates the exemplary result of tree interpolation by the tree interpolation module for perpendicular parking and parallel parking, respectively, according to an embodiment of the disclosure.

FIGS. 6e and 6f illustrate exemplary resulting paths after tree optimization is performed by the tree optimization module for perpendicular parking and parallel parking, respectively, according to an embodiment of the disclosure.

FIG. 7 illustrates the exemplary modules of the trajectory planning module of FIG. 2, according to an embodiment of the disclosure.

FIG. 8 illustrates an exemplar result of trajectory data of a perpendicular parking case, according to an embodiment of the disclosure.

FIG. 9 illustrates an exemplary system block diagram of a vehicle control system of a vehicle including the ADAS of FIG. 1, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

In general, one aspect of this disclosure relates to a hybrid auto-park planner developed through combining and modifying existing sampling-based planning methods. The disclosed hybrid auto-park planner can increase the chance of a successful planning with more reasonable maneuver behavior. Another aspect of this disclosure relates to several new sampling methods of sampling the searching configuration space to promote sampling reasonability based on given scenarios. In yet another aspect, computationally efficient collision check methods are disclosed.

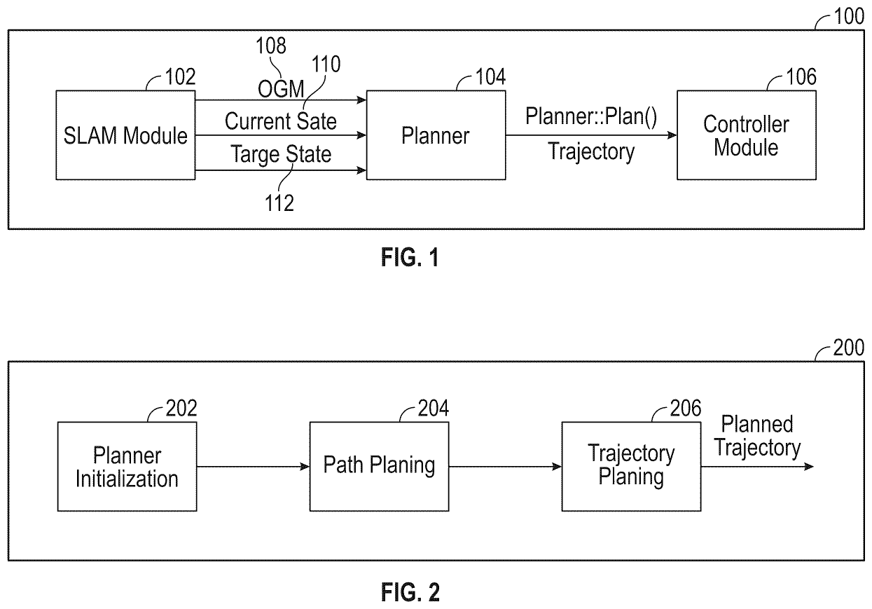

In a first aspect of the disclosure, embodiments of an AP planner are disclosed. FIG. 1 illustrates the exemplary modules of an ADAS, according to one embodiment of the disclosure. The ADAS 100 can include a simultaneous localization and mapping (SLAM) module 102, AP planner 104, and a controller module 106. The SLAM module 102 can build a map and localize the vehicle in that map using well-known SLAM algorithms. The AP planner 104 receives a number of inputs from the SLAM module 102 including an occupancy grip map (OGM) 108, the current state of the vehicle (e.g., x, y coordinates, vehicle heading angle in a fixed coordination system) 110, and the state of the parking target 112. The AP planner 104 outputs a planned trajectory to the controller module 106 for the control module 106 to exercise different control strategy over the movement of the vehicle.

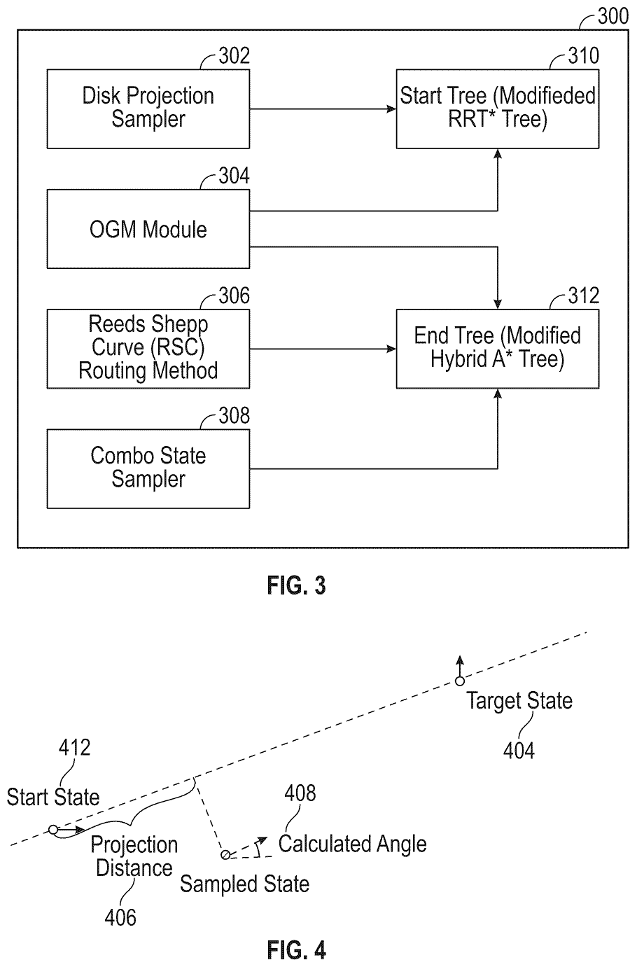

The AP planner 104 can include a number of sub-modules. In one example, as illustrated in FIG. 2, the AP planner 200 includes a planner initialization module 202, a path planning module 204, and a trajectory planning module 206. These modules 202, 204, 206 of the AP planner 200 can carry out planner initialization, path planning, and trajectory planning, respectively, as part of the process of generating a planned trajectory of the vehicle during auto-parking. The operation of each sub-module is discussed in detail in the following paragraphs.

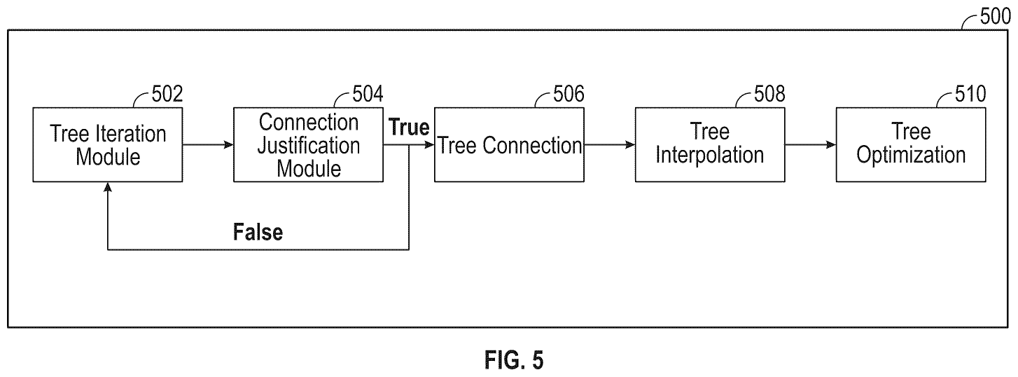

The planner initialization module 300 can include a number of different sub-modules as shown in FIG. 3. These sub-modules can include: disk projection sampler 302, OGM module 304, Reeds Shepp Curve (RSC) routing module 306, combo state sampler 308, start tree 310, and end tree 312.

Overall, as indicated in FIG. 3, the AP planner 300 utilizes a bi-directional tree structure: a starter tree 310 growing from the vehicle's current state and an end tree 312 growing from the parking target. In this embodiment, the start tree can be set as a modified RRT* tree with the disk projection sampler 302 serving as its state sampling agent. The end tree can be set as a modified hybrid A* tree with the combo state sampler 308 serving as its sampling agent. The combo state sampler 308 is used, for both the start tree 310 and the end tree 312, as the routing mechanism that connects the different nodes during path planning. Both the start tree 310 and the end tree 312 are connected to the OGM module 304 to conduct tasks such as obstacle construction analysis, collision check, etc.

The OGM module 304 can be constructed with a binary occupancy grid map (i.e., the OGM map). As an example, the OGM map can be a local map with a reasonable size of 30 m×30 m and a resolution (i.e., grid cell width) of 0.25 m. The OGM module 304 can utilize the orientation-invariant property of the disk to approximate the vehicle shape into 3 disks and further use several rectangles which matches the OGM resolution to represent each disk shape. The rectangles can be saved as a look-up table that could be retrieved for collision checks. The OGM module 304 can perform a state occupancy status check by using the disk decomposition method to check its occupancy status based on a selected state. The OGM module 304 can also perform a path collision free check by using the state occupancy status check to check the sampled state occupancy status based on a pre-set checking density. In some embodiments, considering program running efficiency and the physical shape of the vehicle, it may not be necessary to iterate every sampled point along a path segment to perform the collision check.

Given the specific scenario configuration in parking lots and garages, orientational agile and directional flexible maneuver can be considered during path planning. A combo curve routing (CC routing) method that uses a set of combinations of straight lines and curve lines can be implemented by the OGM module 304 to form a solution space. A collision-free path that connects the start state and the end state can be calculated using the CC routing method.

Referring back to FIG. 3, the disk projection sampler module 302 is designed for the start tree 310 (modified RRT* tree) sampling to fully utilize the structured environment characteristics as well as increasing sampling efficiency. Due to the dense obstacle existence during a parking maneuver, it would not make sense to sample a state far away from the vehicle's current state because 1) the further the sampled sate to the current state, the lower the chance of the CC routing method can find a valid solution due to its specially configured solution space, and 2) it requires more computation time to calculate a valid path segment. Hence, the disk projection sampler module 304 can restrict the sampling range into a disk centered at the current state with a fixed radius. As the disk sampling is used for locking down the sampled state's x and y coordinates, the disk projection sampler can reconstruct a coordinate system that maps the sample state's projection on connection axis to sampled state's yaw angle as follows:

[symbol]

[symbol]

where a linear mapping relationship is assumed.

This method avoids random sampling with no heuristic. The sampling range and the angle of the sampled state plays a dominant factor for sampling quality. By restricting the sampling range and constructing a rule-based sampled state's angle formula, more heuristic can be added into the sampling method to significantly increase the sampling quality and increase the sampling efficiency. This is another aspect of the present disclosure.

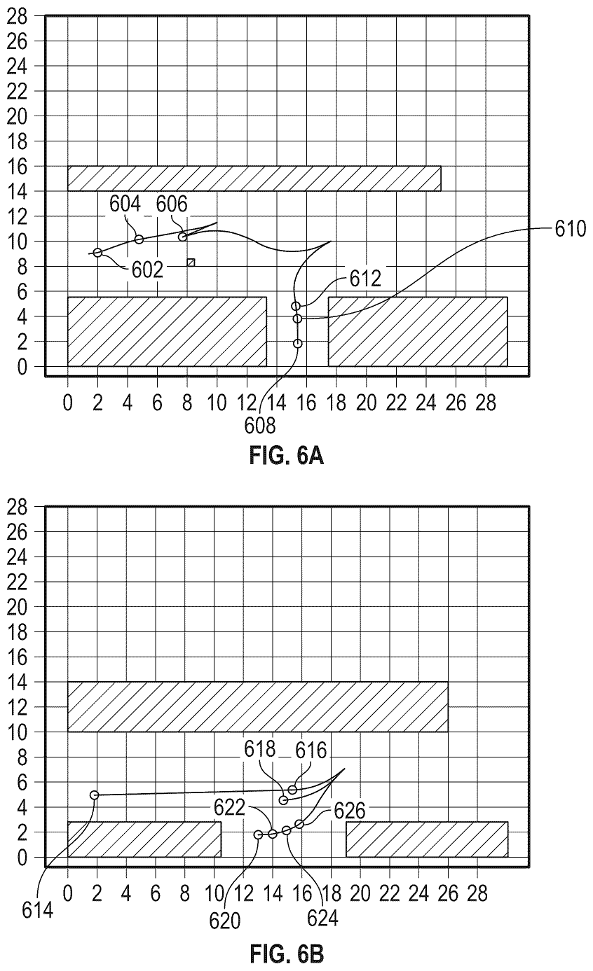

FIG. 4 illustrates the start state 402 (e.g., the current state of the vehicle—the x, y coordinates and yaw angle of the vehicle) and the end state 404. The disk projection sampler module 302 can make a projection on the line connecting the start state 402 and the end state 404, assuming a linear mapping relationship between the yaw angle difference and the projection distance 406. In other words, the yaw angle 408 can be calculated based on the projection distance 406. This allows more heuristic to be introduced.

The combo state sampler 308 is designed to work with the end tree 312 that originates from the target parking slot. The target parking slot is usually a highly structured environment that is typically narrow and often restricted by adjacent vehicles or other obstacles. Because of the positive availability of the pose of the target parking slot due to its highly structured nature, more heuristic is added to help grow the end tree out of the target parking slot. In one embodiment, the combo state sampler 308 can serve as a sampling agent that carries property of the Hybrid A* sampling method, but with more customized heuristic added.

With the vehicle model incorporated, the combo state sampler 308 can be in a sampling state in which the vehicle is either operating in a monodirectional straight line or in vehicle's maximum steering wheel angle, both of which at a fixed distance. Because the vehicle's pose and the target parking slot pose are both available, the direction (along the orientation axis of target parking slot) of growing trees can be easily set. To reduce redundancy and repetition, a visited state list can be set up to prevent repetitious sampling.

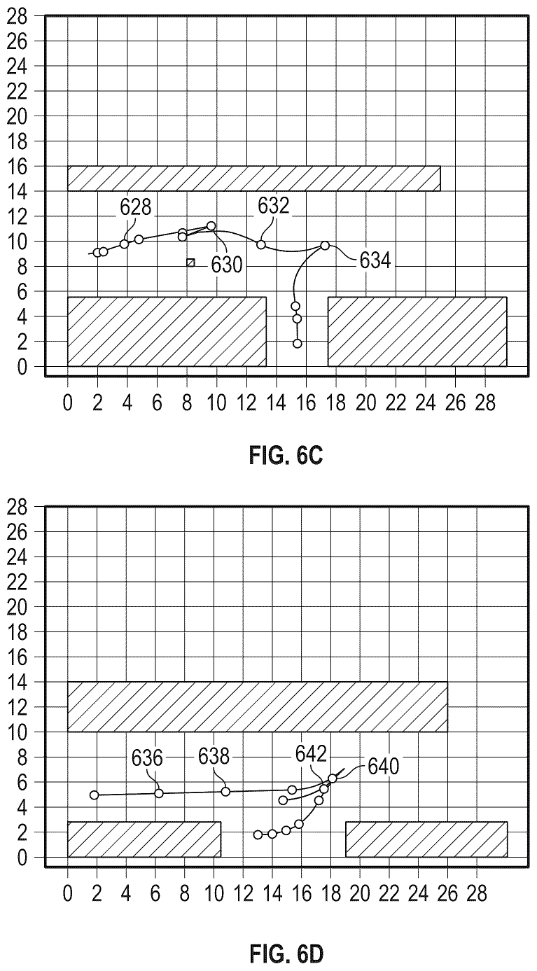

Referring back to FIG. 2, after the planner initialization module 202 initializes the hybrid planner as discussed above, the path planning module 204 can plan out a path. In one embodiment, the path planning module 500 can include a tree iteration module 502, a connection justification module 504, a tree connection module 506, a tree interpolation module 508, and a tree optimization module 510, as illustrated in FIG. 5.

The tree iteration module 502 conducts an iteration of the start tree (modified RRT* tree) during path planning. The tree iteration module 502 also conducts an iteration of the end tree (modified Hybrid A* tree) but only when the number of the end tree's nodes does not exceed a predefined threshold. The reason for that is 1) the end tree's node number will grow exponentially if not limited, which would consume too much computation resources for routing, and 2) once the end tree grows out of the narrow parking lot, the iteration result of the start tree plays a more dominant role of a successful connection between the start tree and the end tree.

The two trees can continue iterating until the connection justification module 504 determines with a threshold confidence level that the two trees can be connected. Once this determination is made, information about the two trees can be passed on to the tree connection module 506, which can connect the two trees. If the confidence level of a connection can be made by the two trees does not meet the threshold, the tree iteration module 502 will continue to iteration of the trees.

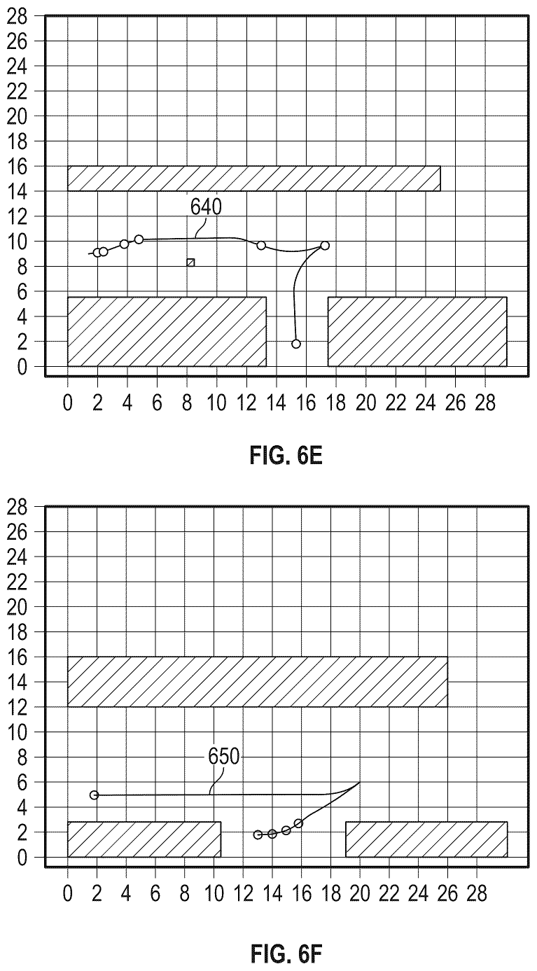

FIGS. 6a and 6b illustrate the results of the tree connection by the tree connection module 506 for perpendicular and parallel parking, respectively. FIG. 6a shows nodes 602, 604, 606 from the start tree connected to nodes 608, 610, 612 of the end tree. Similarly, FIG. 6b shows nodes 614, 616, 618 of the start tree connected to nodes 620, 622, 624, 626 of the end tree.

Normally, the start tree and the end tree are connected in a sparse way that would be difficult to translate into a refined maneuver of the vehicle (e.g., similar to one that a human driver would perform) due to the limitations of the CC routing method. The tree interpolation module 508 can interpolate nodes between these sparse nodes to expand solution space for the downstream tree optimization module 510.

FIGS. 6c and 6d illustrates the result of tree interpolation by the tree interpolation module 508 for perpendicular parking and parallel parking, respectively. As illustrated in these figures, new nodes (e.g., 628, 630, 632, 634 in FIGS. 6c and 636, 638, 640, 642 in FIG. 6d) are constructed by the tree interpolation module 508.

After tree interpolation is completed, a more refined path pattern can be generated by the tree optimization module 510 based on the existing tree connection result. One of the core functions of the tree optimization module 510 is to rewire the current node and iterate over all existing nodes trying to find a new parental-child relationship between different nodes with lower cost. When the rewire function is triggered, the target nodes can be rewired using the same CC routing method discussed above.

Because the CC routing method used by the previous modules operates the vehicle in its agilest maneuver, e.g., maximum steering angle, there may still be some corner cases containing unreasonable path pattern even after rewiring. For example, when performing the parking maneuver, human drivers are not always limited to steering the vehicle in straight line and drastically turning the vehicle. The rewiring method is modified accordingly by expanding the turning radius space, where the planner can carry out rewiring according to the CC routing method with different vehicle turning radius. This will achieve a more refined path pattern.

FIGS. 6e and 6f illustrate the resulting refined paths after tree optimization is performed by the tree optimization module 510 for perpendicular parking and parallel parking, respectively. As shown in these figures, paths 640 (FIGS. 6e) and 650 (FIG. 6f) are more refined than the corresponding pre-tree optimized paths shown in FIGS. 6c and 6d, respectively.

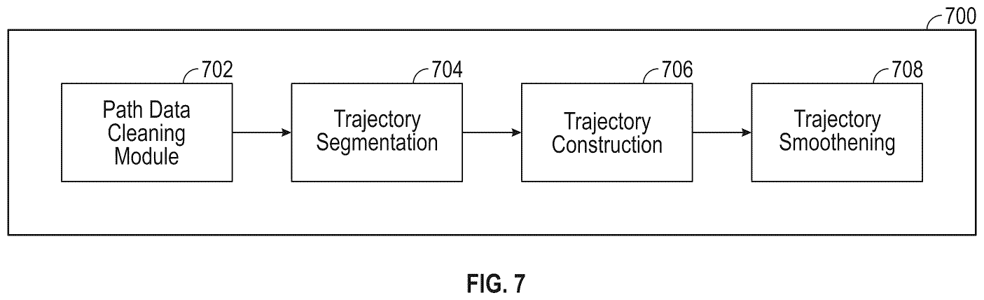

Referring again to FIG. 2, the paths generated and optimized by the path planning module 204 is output to the trajectory planning module 206. FIG. 7 illustrates the exemplary modules of the trajectory planning module 206, according to one embodiment of the disclosure. The trajectory planning module 700 can include a path data cleaning module 702, a trajectory segmentation module 704, a trajectory construction module 706, and a trajectory smoothening module 708.

The path data cleaning module 702 can serve the purpose of eliminating directional oscillation data before trajectory planning. The trajectory segmentation module 704 can separate the planned path into segments based on the number of cusp points that are indicators of a full stop and directional reversal. The total task time is a fixed number and the trajectory segmentation module 704 can allocate time to different path segments proportionally to their lengths.

The trajectory construction module 706 can construct the trajectory using an S Curve method that defines a time-symmetric stop-to-stop maneuver. To take comfortability into account as well, a curvature changing rate indicator can adjust the trajectory's peak speed based on a scaled average curvature changing rate of a trajectory.

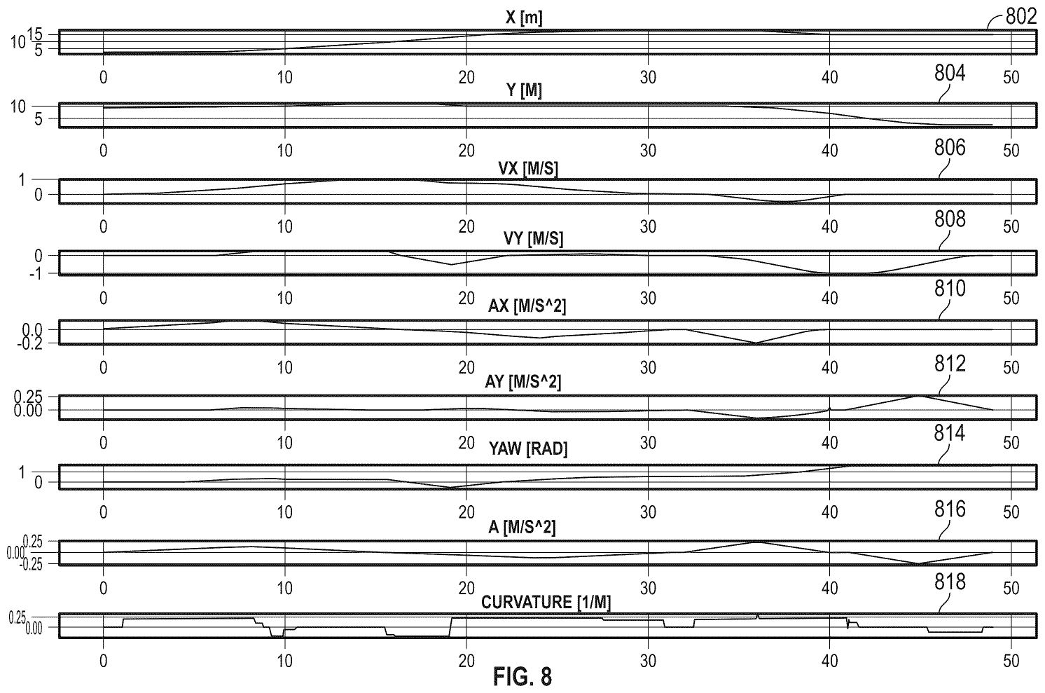

The trajectory smoothening module 708 can smoothen the generated trajectory data without violating the kinematic and dynamic constraints. An exemplar result of a perpendicular parking case is shown in FIG. 8. Specifically, FIG. 8 shows the changes in the vehicle's x, y coordinates 802, 804, velocity in x, y directions 806, 808, acceleration in x, y directions 810, 812, yaw 814, acceleration 816, and turning curvature 818.

Referring back to FIG. 1, after the AP planner 104 generates the trajectory as discussed above, the trajectory can be output to the controller module 106, which, in turn, can send control signals to various actuation systems of the vehicle to automatically park the vehicle according to the trajectory.

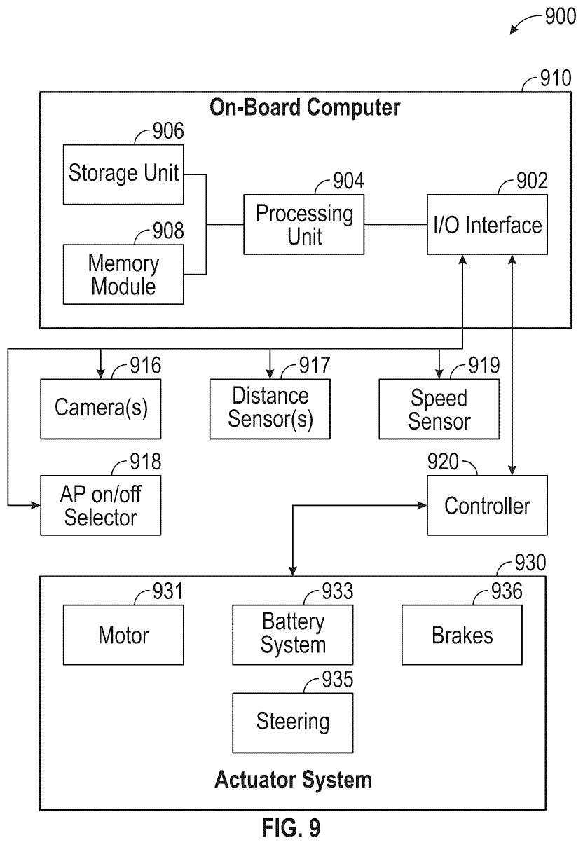

FIG. 9 illustrates an exemplary system block diagram of a vehicle control system 900 of a vehicle including the ADAS 100 of FIG. 1, according to an embodiment of the disclosure. System 900 can be incorporated into a vehicle of any body style, such as but not limited to, a sports car, a coupe, a sedan, a pick-up truck, a station wagon, a sports utility vehicle (SUV), a minivan, or a conversion van. The vehicle may be an electric vehicle, a fuel cell vehicle, a hybrid vehicle, or any other types of vehicles that are fitted with regenerative braking.

Vehicle control system 900 can include one or more cameras 916 capable of capturing image data (e.g., video data) of the vehicle's surroundings. In one embodiment, the one or more cameras 906 can be front facing and/or rear facing capable of detecting objects around the vehicle. Additionally or alternatively, vehicle control system 900 can also include one or more distance sensors 917 (e.g., radar, ultrasonic, and LIDAR) capable of detecting various characteristics of the vehicle's surroundings. Additionally, vehicle control system 900 can include a speed sensor 919 for determining the speed of the vehicle. The camera(s) 916, distance sensor(s) 917, and speed sensor 919 can be part of the ADAS of the vehicle.

Additionally, vehicle control system 900 can include one or more user interfaces (UIs) 918 configured to receive input from the driver to control the movement of the vehicle. In one embodiment, the UIs 918 can include an auto-parking on/off selector that would allow a user (driver) to engage/disengage the auto-parking feature of the vehicle.

Vehicle control system 900 includes an on-board computer 910 that is operatively coupled to the cameras 916, distance sensors 917, speed sensor 919, and UIs 918. The on-board computer 910 is capable of receiving the image data from the cameras and/or outputs from the sensors 917, 919. The on-board computer 910 can also receive outputs from the UIs 918.

In accordance with one embodiment of the disclosure, the on-board computer 910 can be configured to operate the auto-parking system 900 in response to the data/outputs from the camera(s) 916, sensor(s) 917, speed sensor 919, and UIs 918.

In some examples, the on-board computer 910 may include, among other modules, a I/O interface 902, a physical processing unit 904, a storage unit 906, and a memory module 908. The on-board computer 910 may be specialized to perform the auto-parking maneuver in the embodiments described above.

I/O interface 902 may be configured for two-way communication between on-board computer 910 and various components of vehicle control system 900, such as camera(s) 916, distance sensor(s) 917, UIs 918, speed sensor 919, as well as a controller 920. I/O interface 902 may send and receive the data between each of the devices via communication cables, wireless networks, or other communication mediums.

Processing unit 904 may be configured to receive signals and process the signals to determine a plurality of conditions of the operation of the vehicle, for example, through controller 920. For example, processing unit 904 can receive image/video data from camera(s) 916 and/or sensor data from distance sensor(s) 917. The processing unit 904 can determine based on the image/video and sensor data the boundary of the parking space and whether there is another object in the path of the vehicle by analyzing the image/video and sensor data. In some embodiments, the processing unit 904 can determine a distance to other objects. Processing unit 904 can also receive user input (e.g., switching on/off AP) from UIs 918. Additionally, processing unit 904 can also receive the speed of the vehicle from the speed sensor 919.

Processing unit 904 may also be configured to generate and transmit command signals, via I/O interface 902 to controller 920 in order to actuate the various actuator systems 930 of the vehicle control system 900 as described below.

Storage unit 906 and/or memory module 908 may be configured to store one or more computer programs that may be executed by on-board computer 910 to perform functions of system. For example, storage unit 906 and/or memory module 908 may be configured to process instructions to enable the auto parking functions described herein.

Vehicle control system 900 may also include a controller 920 connected to the on-board computer 910 and capable of controlling one or more aspects of vehicle operation, such as performing auto parking operations using instructions from the onboard computer 910.

In some examples, the controller 920 is connected to one or more actuator systems 930 in the vehicle. The one or more actuator systems 930 can include, but are not limited to, a motor (or engine) 931, battery system 933, steering 935, and brakes 936. The on-board computer 910 can control, via controller 920, one or more of these actuator systems 930 during vehicle operation, for example, to control the speed and direction of the vehicle when auto-parking is engaged, using the motor 931, battery system 933, steering 935, brakes 936, and other actuator systems (not illustrated in FIG. 9).

A person skilled in the art can further understand that, various exemplary logic blocks, modules, submodules, circuits, and algorithm steps described with reference to the disclosure herein may be implemented as specialized electronic hardware, computer software, or a combination of electronic hardware and computer software. For examples, the modules and submodules may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. Each of the modules and submodules of FIGS. 1-1-3, 5, and 7 may be implemented in software, hardware, firmware, or a combination thereof.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An auto parking system of a vehicle comprising:
a planner initialization module configured to perform sampling of both a start state representing a state of the vehicle and an end state representing a state of the parking target;
a path planning module configured to perform tree iteration of a start tree from the start state and an end tree from the end state and connect nodes from the start tree and the end tree to generate path data; and
a trajectory planning module configured to receive the path data from the path planning module and construct a trajectory of the vehicle based on the path data;
where the start tree and end tree comprise two different types of tree structures.

2. The auto parking system of claim 1, wherein the start tree comprises a modified RRT* tree.

3. The auto parking system of claim 1, wherein the end tree comprises a modified hybrid A* tree.

4. The auto parking system of claim 1, wherein the path planning module comprises an occupancy grid map (OGM) module configured to perform state occupancy status checks and path collision free checks.

5. The auto parking system of claim 1, wherein the path planning module comprises a combo curve routing method module configured to use a set of combinations of straight lines and curve lines to form a solution space.

6. The auto parking system of claim 5, wherein the path planning module is further configured to calculate a collision-free path that connects a start state and an end state.

7. The auto parking system of claim 1, wherein the path planning module comprises a disk projection sampler module configured to perform tree sampling of the start tree.

8. The auto parking system of claim 7, wherein the disk projection sampler is configured to restrict a sampling range into a disk centered at a current state with fixed radius.

9. The auto parking system of claim 7, wherein the path planning module comprises a combo state sampler module configured to grow the end tree from the end state.

10. The auto parking system of claim 9, wherein the combo state sampler module is configured to set up a visited state list to prevent repetitious sampling of the end tree.

11. The auto parking system of claim 1, wherein the path planning module comprises a tree iteration module configured to conduct iterations of the start tree and the end tree.

12. The auto parking system of claim 11, wherein the tree iteration module conducts iterations of the end tree only when a number of nodes of the end tree is below a predefined threshold.

13. The auto parking system of claim 1, wherein the path planning module comprises a connection justification module configured to determine that the start tree and the end tree can be connected.

14. The auto parking system of claim 13, wherein the path planning module comprises a tree connection module configured to connect the start tree and the end tree if the connection justification module determines that the start tree and the end tree can be connected.

15. The auto parking system of claim 1, wherein the path planning module comprises a tree interpolation module configured to interpolate of the start tree and the end tree.

16. The auto parking system of claim 15, wherein the path planning module comprises a tree optimization module configured to generate a refined path pattern based on a connection between the start tree and the end tree resulting from the interpolation of the start tree and the end tree.

17. The auto parking system of claim 16, wherein the tree optimization module is configured to rewire according to CC routing using different vehicle turning radius.

18. The auto parking system of claim 11, wherein the trajectory planning module comprises a path data cleaning module configured to eliminate directional oscillation data.

19. The auto parking system of claim 11, wherein the trajectory planning module comprises a trajectory segmentation module configured to separate the path into segments based on a number of cusp points that are indicators of a fully stop and directional reversal.

20. The auto parking system of claim 11, wherein the trajectory planning module comprises:
a trajectory construction module configured to construct a trajectory of the vehicle using an S Curve method; and
a trajectory smoothing module configured to smoothening the trajectory.
